(19) United States
(12) Patent Application Publication
(10) Pub. No.: US 2010/0253093 A1
(43) Pub. Date: Oct. 7, 2010

(54) LINEAR INDUCTION GENERATOR

(76) Inventor: Raymond Milton Mac Donald, Ridgecrest, CA (US)

Correspondence Address: Raymond Mac Donald, 100 S. Lilac Street, Ridgecrest, CA, 93555, US

(21) Appl. No.: 12/730,175

(22) Filed: Mar. 23, 2010

Related U.S. Application Data
(60) Provisional application No. 61/166,857, filed on Apr. 6, 2009.

(51) Int. Cl. H02K 7/18; H02K 35/02; H02K 53/00

(52) U.S. Cl. 290/1 R; 310/30; 415/916

(57) ABSTRACT

A magnet may move within a coil-wrapped set of concentric tubes. The magnet may be moved from one end to the other by energizing solenoids located on each end of the set of tubes. The power consumed by the solenoids may be less than the power generated by the movement of the magnet.

### CROSS-REFERENCE TO RELATED APPLICATIONS

This application claims the benefit of U.S. Provisional application No. 61/166,857, filed Apr. 6, 2009, herein incorporated by reference.

### BACKGROUND OF THE INVENTION

The present invention generally relates to electricity generation and, more specifically, to a linear induction generator for producing electricity.

Electricity is typically generated through a mechanical force being applied to a device, such as a rotor of a permanent magnet generator. The energy for this mechanical force is typically supplied through the burning of fossil fuels.

As can be seen, there is a need for a device that generates electricity without the need to expend fossil fuels.

### SUMMARY OF THE INVENTION

In one aspect of the present invention, a power generation device comprises an inner tube wrapped with a first wire; an outer tube wrapped with a second wire, the outer tube circumscribing the first wire of the inner tube; a permanent magnet adapted to move within the inner tube; a first solenoid, wrapped with a first solenoid wire, at a first end of the inner tube; and a second solenoid, wrapped with a second solenoid wire, at a second end of the inner tube.

These and other features, aspects and advantages of the present invention will become better understood with reference to the following drawings, description and claims.

### BRIEF DESCRIPTION OF THE DRAWINGS

FIG. 1 is a partial cross-sectional side view of the assembled linear induction generator according to an embodiment of the present invention;

FIG. 2 is a partial cross-sectional side view of the linear induction generator of FIG. 1;

FIG. 3 is a partially cut-away cross-sectional side view of the linear induction generator of FIG. 1;

FIG. 4 is a close-up cross-sectional side view of the linear induction generator of FIG. 1; and

FIG. 5 is an electrical schematic of the linear induction generator of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a device for generating electrical power by moving a magnet within a coil wrapped set of concentric tubes. The magnet may be moved from one end to the other by energizing solenoids located on each end of the set of tubes. The power consumed by the solenoids may be less than the power generated by the movement of the magnet. Therefore, the linear induction generator of the present invention may result in a positive net power generation, that is, the linear induction generator may generate more power than it consumes.

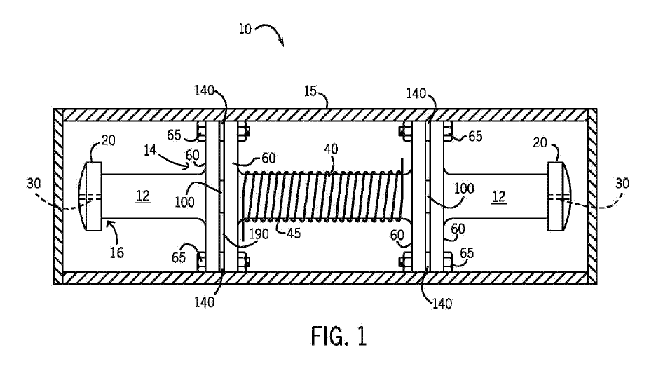

Referring to FIG. 1, a linear induction generator 10 (also simply referred to as generator 10) may include a housing 15 encasing a set of tubes that may include end outer tubes 12 and a central outer tube 40. The first end 14 of each of the end outer tubes 12 and each end of the central outer tube 40 may be joined together, as described below, by flanges 60. In one embodiment, the flanges 60 may be integral with the outer tubes 12, 40. Adjacent flanges 60 may be held together by conventional means, such as a bolt 65. A washer 140 may be disposed on the bolt 65, between the adjacent flanges 60, thereby providing an air gap 190 between the adjacent flanges 60. Second ends 16 of the end outer tubes 12 may have end caps 20 attached thereto. The end caps 20 may have a vent hole 30 formed therein to fluidly communicate the inside of the outer tubes 12 40 with the outside of the tubes 12 40. Windings 45 may wrap around the central outer tube 40.

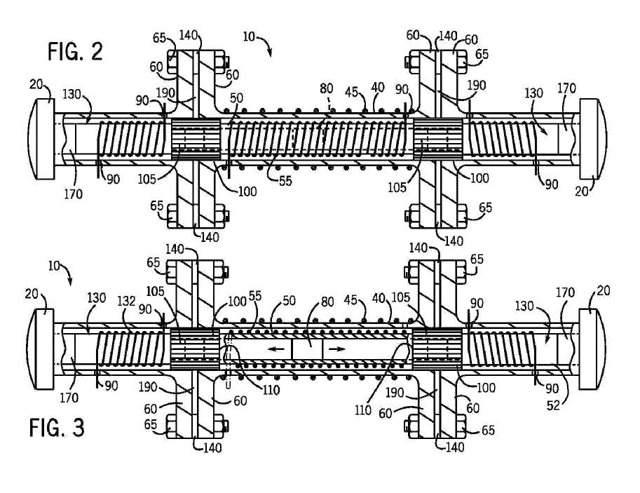

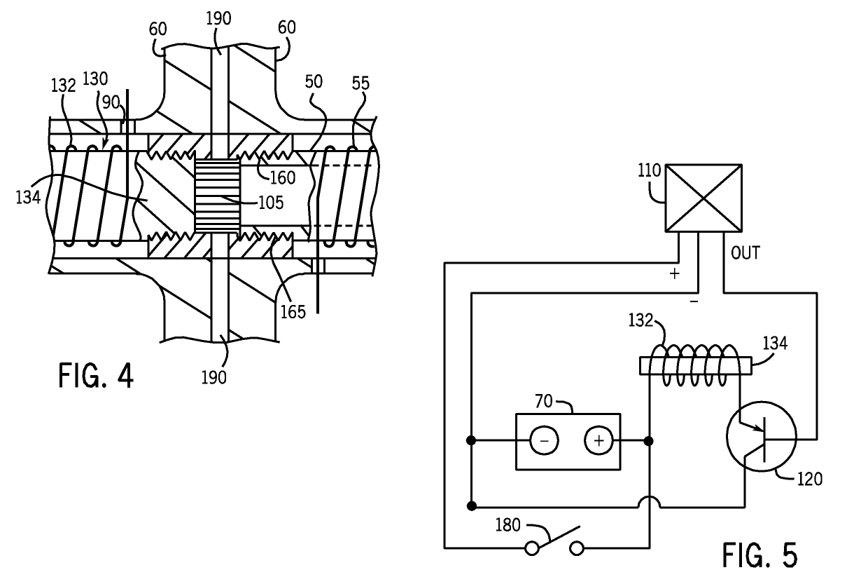

Referring to FIGS. 2 through 4, within the central outer tube 40 may be a central inner tube 50. The central inner tube 50 may be wrapped with a wire 55 and a permanent magnet 80 may be contained therewithin. The magnet 80 may be sized to move from side to side within the central inner tube 50. The wire 55 may extend through holes 90 in the central outer tube 40.

A solenoid 130 may be disposed within each end outer tube 12. The solenoids 130 may be wrapped by solenoid windings 132. The windings 132 may extend through holes 90 in the end outer tube 12 to allow connection to the circuit of FIG. 5. The solenoid 130 may include a solenoid core rod 134 which may be made of a material having a low magnetic property of retentivity. The solenoid may be contained within an end inner tube 52. A spacer 170 may be disposed between the solenoid 130 and the end cap 20 to immobilize the solenoids 130 and the central inner tube 50.

Windings (not shown) may also wrap around end outer tubes 12. When the solenoids 130 are energized, magnetic flux is produced that may intersect with windings on the end outer tubes 12 which may generate an electric pulse. When the solenoids 130 are deenergized, the collapsing magnetic field may produce another pulse.

A female threaded coupling 100 may be disposed between adjacent flanges 60. The solenoid 130 may have male threads 165 on one end of the solenoid core rod 134 adapted to be threaded onto female threads 160 on outside ends of the coupling 100. The central inner tube 50 may thread onto inner ends of the coupling 100. Fluted ventilation openings 105 may be formed in the coupling 100. The fluted ventilation openings 105 may fluidly communicate with the air gap 190 and through holes on the circumference of the coupling 100 (not shown).

Hall effect transistors 110 may be positioned on the inner ends of the couplings 100. The Hall effect transistors 110 may sense the magnet's position and reverse the polarity of the solenoid 130 using the circuit of FIG. 5.

Referring to FIG. 5, a battery pack 70 may supply power to the solenoid windings 132 (only one set of solenoid windings 132 are shown in FIG. 5). One of the solenoids 130 may be wound so that, when energized, it may present a South pole to the South pole of the magnet 80. The other solenoid may be wound so that, when energized, it may present a North pole to the North pole of the magnet 80. When the magnet 80, in motion inside the central inner tube 50, approaches the South pole-wound solenoid 130 (due to energizing the North pole-wound solenoid 130 via a power transistor 120), the position sensing device, such as the Hall effect transistor 110, may sense the approaching magnet 80 and energize the South pole-wound solenoid 130. Similarly, when the magnet 80 approaches the North pole-wound solenoid 130 (due to energizing the South pole-wound solenoid 130), the Hall effect transistor 110, may sense the approaching magnet 80 and energize the North pole-wound solenoid 130. This may result in the magnet 80 moving back and forth within central inner tube 50, thereby inducing electricity in both wires 45 and 55. This generated electricity may be used to recharge the battery pack 70 and provide power to various loads (not shown). A switch 180 may be used to activate/deactivate the generator 10.

While the Figures show a single set of concentric wire-wound tubes of a set size, the linear induction generator 10 according to embodiments of the present invention, may be scalable by the addition of additional concentric wire-wound tubes and/or by adjusting the length and diameter of the tubes. Furthermore, scalability may be achieved by adjusting the density of wire turns around each of the tubes (e.g., central outer tube 40, central inner tube 50, and end outer tubes 12). Scalability may also be achieved by adjusting the current supplied to the wire turns (e.g., wire 45 and wire 55) or by adjusting the size and strength of the magnet 80.

It should be understood, of course, that the foregoing relates to exemplary embodiments of the invention and that modifications may be made without departing from the spirit and scope of the invention as set forth in the following claims.

What is claimed is:

1. A power generation device comprising:
an inner tube wrapped with a first wire;
an outer tube wrapped with a second wire, the outer tube circumscribing the first wire of the inner tube;
a permanent magnet adapted to move within the inner tube;
a first solenoid, wrapped with a first solenoid wire, at a first end of the inner tube; and
a second solenoid, wrapped with a second solenoid wire, at a second end of the inner tube.

2. The power generation device of claim 1, wherein:
the first solenoid is contained within a first end outer tube; and
the second solenoid is contained within a second end outer tube.

3. The power generation device of claim 3, wherein:
the first end outer tube is attached to a first half of a first flange;
the second end outer tube is attached to a first half of a second flange;
a first end of the outer tube is attached to a second half of the first flange; and
a second end of the outer tube is attached to a second half of the second flange.

4. The power generation device of claim 3, wherein:
the first half and the second half of the first flange are joined with a bolt and nut;
the first half and the second half of the second flange are joined with a bolt and nut;
a first washer is disposed between the first and second halves of the first flange to provide a first air gap between the first and second halves of the first flange; and
a second washer is disposed between the first and second halves of the second flange to provide a second air gap between the first and second halves of the second flange.

5. The power generation device of claim 4, further comprising:
a first coupling between the first half and the second half of the first flange; and
a second coupling between the first half and the second half of the second flange,
wherein the coupling has female threads therewithin.

6. The power generation device of claim 5, further comprising fluted ventilation openings in the first and second couplings, the fluted ventilation openings communicating with the first and second air gaps.

7. The power generation device of claim 2, further comprising:
first and second end caps disposed at ends of the first and second end outer tubes; and
air holes formed through the first and second end caps.

8. The power generation device of claim 5, further comprising first and second position sensing devices detect the position of the magnet within the inner tube.

9. The power generation device of claim 8, wherein the first and second position sensing devices are Hall effect transistors.

10. The power generation device of claim 5, further comprising at least one battery pack, the battery pack supplying power to energize the solenoids, and the battery pack receiving power generated by the movement of the magnet via the first and second wires, wherein the power generated by the device is greater than the power used by the device.

11. The power generation device of claim 2, further comprising windings around the first and second end outer tubes.
